(19) United States
(12) Patent Application Publication
(10) Pub. No.: US 2020/0174215 A1
(43) Pub. Date: Jun. 4, 2020

(54) IMAGING DEVICE

(71) Applicant: Nidec Copal Corporation, Tokyo (JP)

(72) Inventor: Yuta NAKAMURA, Tokyo (JP)

(21) Appl. No.: 16/633,872

(22) PCT Filed: Jun. 20, 2018
(86) PCT No.: PCT/JP2018/023381

§ 371 Date: Jan. 24, 2020

(30) Foreign Application Priority Data
Jul. 26, 2017 (JP) 2017-144642

(51) Int. Cl. G02B 7/02; G03B 17/56; H04N 5/225; B60R 11/04; G03B 17/02

(52) U.S. Cl. CPC G02B 7/022; G03B 17/56; H04N 5/2254; H04N 5/2252; G03B 17/02; H04N 5/2253; H04N 5/2257; B60R 11/04

(57) ABSTRACT

An imaging device includes a substrate on which an image sensor is mounted, a lens barrel holding a lens, and a case covering the substrate and the lens barrel. The substrate has a first V-shaped portion and a second V-shaped portion. The first V-shaped portion includes a first straight line and a second straight line each extending straight on a plane perpendicular to an optical axis. The second V-shaped portion includes a third straight line and a fourth straight line each extending straight on the plane perpendicular to the optical axis. The first straight line and the second straight line have an intersection located symmetrically to an intersection between the third straight line and the fourth straight line about a straight line perpendicular to the optical axis.

### RELATED APPLICATIONS

The present application is National Phase of International Application Number PCT/JP2018/023381, filed Jun. 20, 2018, and claims priority based on Japanese Patent Application No. 2017-144642, filed Jul. 26, 2017.

### FIELD

An embodiment of the present invention relates to, for example, an imaging device.

### BACKGROUND

An imaging device may include a case accommodating a lens barrel and a substrate on which an image sensor is mounted. In this imaging device, the substrate with the image sensor is secured to the case or to a lens flange with fasteners, such as screws, to appropriately position the image sensor with respect to the optical axis. An example structure described in Patent Literature 1 uses a special washer to increase the positioning precision of an image sensor.

### CITATION LIST

### Patent Literature

Patent Literature 1: Japanese Unexamined Patent Application Publication No. 2015-56818

### BRIEF SUMMARY

### Technical Problem

In the known structure, the substrate with the image sensor may rotate and be misaligned as any screw rotates when the substrate is secured with screws. The image sensor may not easily be in position with respect to the optical axis.

### solution to problem

In response to the above issue, one or more aspects of the present invention are directed to the structures described below. The reference numerals or other labels in parentheses herein denote the corresponding components in the figures to facilitate understanding of the aspects of the present invention. However, the components with such reference numerals do not limit the components according to the aspects of the present invention, which should be construed broadly within the scope technically understandable by those skilled in the art.

An imaging device according to one aspect of the present invention includes a substrate (5) on which an image sensor is mounted, a lens barrel (2) holding a lens, and a case (1, 7) covering the substrate and the lens barrel. The substrate (5) has a first V-shaped portion (52a) and a second V-shaped portion (52b). The first V-shaped portion includes a first straight line and a second straight line each extending straight on a plane perpendicular to an optical axis. The second V-shaped portion includes a third straight line and a fourth straight line each extending straight on the plane perpendicular to the optical axis. The first straight line and the second straight line have an intersection located symmetrically to an intersection between the third straight line and the fourth straight line about a straight line perpendicular to the optical axis.

In the imaging device according to the above aspect, the substrate is positioned with a jig applied to the straight lines of the first V-shaped portion and the second V-shaped portion. The substrate is positioned precisely without increasing the number of components. The image sensor is thus positioned precisely with respect to the optical axis.

In the above imaging device, the substrate may be substantially rectangular. The substrate may have a first side having the first V-shaped portion, and a second side having the second V-shaped portion. The second side may be opposite to the first side.

In the imaging device with the above structure, the first V-shaped portion and the second V-shaped portion can be located relatively easily. The relatively simple structure allows precise positioning of the image sensor with respect to the optical axis.

In the above imaging device, the first straight line may be parallel to the third straight line, and the second straight line may be parallel to the fourth straight line.

In the imaging device with the above structure, the first V-shaped portion and the second V-shaped portion can each receive a force in a balanced manner when the substrate is positioned using a jig. The image sensor can thus be easily positioned precisely with respect to the optical axis.

The above imaging device may further include a lens flange (4) holding the lens barrel and connected to the case. The substrate may be secured to the lens flange.

The imaging device with the above structure easily retains the substrate in position with respect to the optical axis.

In the above imaging device, the first straight line and the second straight line may be symmetrical about the straight line perpendicular to the optical axis, and the third straight line and the fourth straight line may be symmetrical about the straight line perpendicular to the optical axis.

In the imaging device with the above structure, the substrate can be positioned with a jig under a force from the jig applied uniformly across the substrate. This easily allows more precise positioning of the substrate with respect to the optical axis.

In the above imaging device, the first V-shaped portion and the second V-shaped portion may be cutouts each extending inward from edges of the substrate.

In the imaging device with the above structure, the substrate can be shaped relatively easily.

In the above imaging device, the substrate may be secured in position with a screw.

The imaging device with the above structure is repairable, and also allows precise positioning of the substrate with respect to the optical axis. The first V-shaped portion and the second V-shaped portion reduce the possibility of misalignment that may occur when the screw is rotated to secure the substrate.

In the above imaging device, the first straight line may form an internal angle of about 60 degrees with the second straight line, and the third straight line may form an internal angle of about 60 degrees with the fourth straight line.

In the imaging device with the above structure, the first V-shaped portion and the second V-shaped portion each defined by the straight lines are angled appropriately. This allows more precise positioning of the substrate with respect to the optical axis.

### BRIEF DESCRIPTION OF DRAWINGS

FIG. 1 is an external front perspective view of an imaging device according to an embodiment.

FIG. 2 is an external rear perspective view of the imaging device according to the embodiment.

FIG. 3 is an exploded front perspective view of the imaging device according to the embodiment.

FIG. 4 is an exploded rear perspective view of the imaging device according to the embodiment.

FIG. 5 is an enlarged view of a substrate according to the embodiment.

FIG. 6 is a rear perspective view of the imaging device according to the embodiment showing a lens barrel, a waterproof seal, a lens flange, and the substrate connected together.

FIG. 7 is a rear perspective view of the imaging device according to the embodiment with the substrate being positioned using a jig.

FIG. 8 is an enlarged view of a substrate according to a first comparative example.

FIG. 9 is an enlarged view of a substrate according to a second comparative example.

### DETAILED DESCRIPTION

An imaging device according to one embodiment of the present invention includes a substrate having a first V-shaped portion and a second V-shaped portion, on which an image sensor is mounted. The substrate can be positioned precisely with a jig.

An optical axis herein refers to the center of a lens, and also the center of light entering the image sensor. An imaging target located opposite to the image sensor from the lens is herein referred to as a subject. The front or frontward in the optical axis direction refers to the direction in which the subject is located as viewed from the image sensor, whereas the rear or rearward in the optical axis direction refers to the direction in which the image sensor is located as viewed from the subject.

The structure according to an embodiment of the present invention will now be described. The embodiment described below is merely an example of the present invention, and should not be construed as limiting the technical scope of the invention. In the figures, the same components are given the same reference numerals, and may not be described.

1. Embodiment

2. Supplemental Examples

### 1. Embodiment

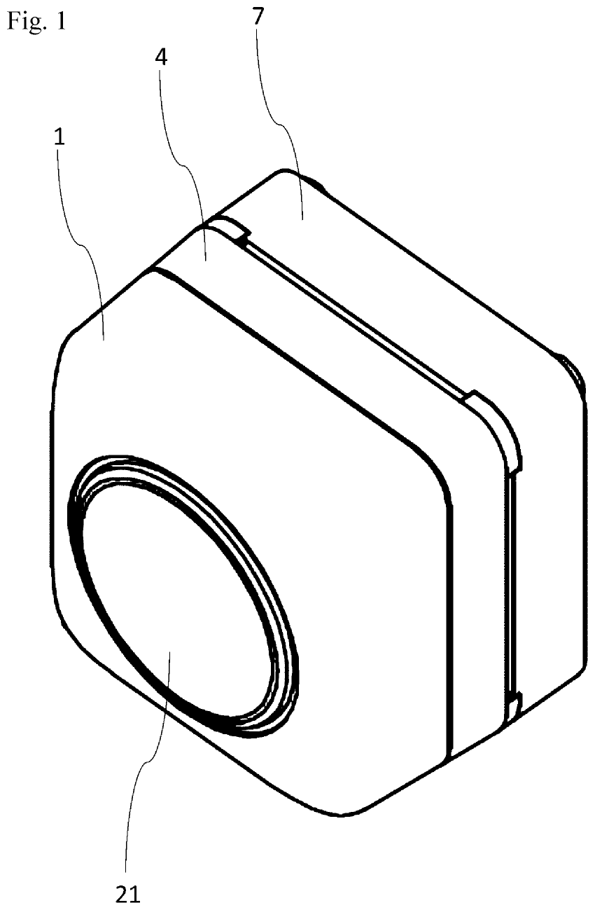

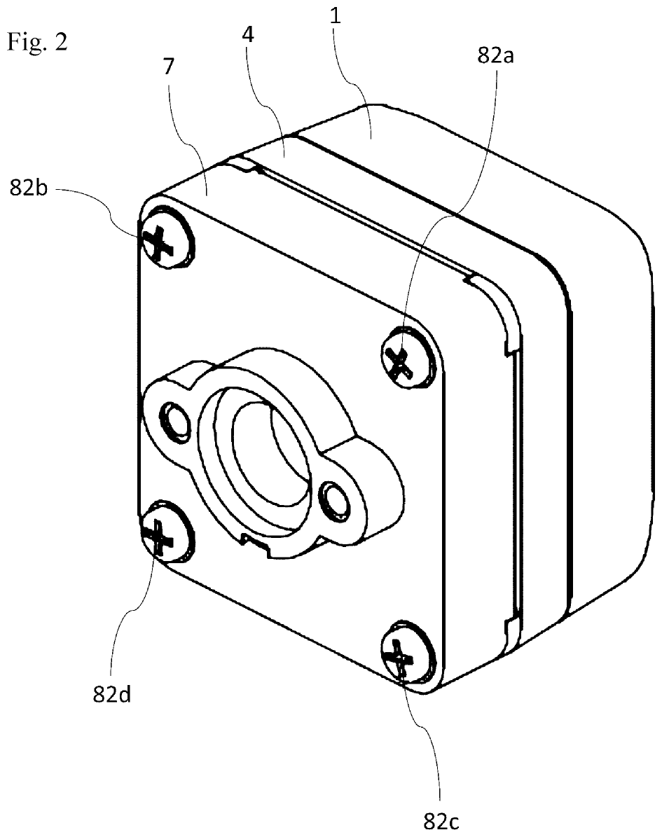

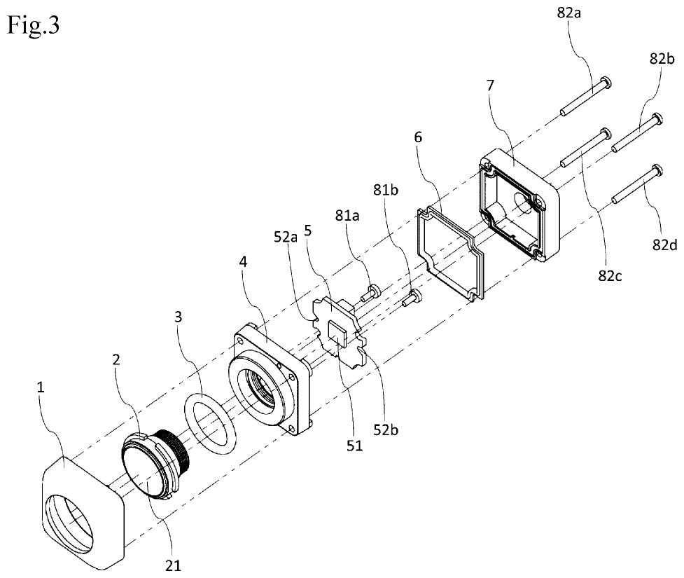

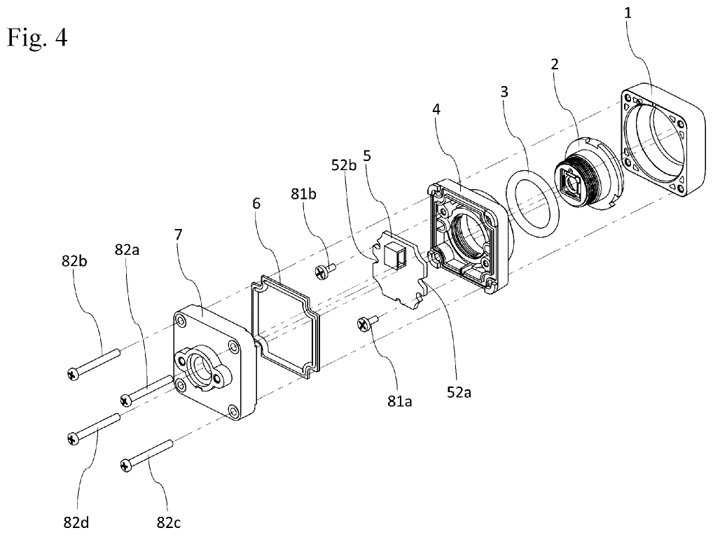

An embodiment of the present invention will be described with reference to the drawings. FIGS. 1 and 2 are external perspective views of an imaging device according to the present embodiment. FIG. 1 is a front view, and FIG. 2 is a rear view. FIGS. 3 and 4 are exploded perspective views of the imaging device according to the present embodiment. FIG. 3 is a front view, and FIG. 4 is a rear view.

As illustrated, the imaging device according to the present embodiment includes a front case 1, a lens barrel 2, a waterproof seal 3, a lens flange 4, a substrate 5, a waterproof seal 6, a rear case 7, connection screws 81a and 81b, and connection screws 82a to 82d.

### Front Case 1

The front case 1 forms a housing (case) accommodating the imaging device, together with the rear case 7. The front case 1 is formed from, for example, resin. The front case 1 has an opening at the front in the optical axis direction, with the optical axis at the center. The front case 1 has, at the rear in the optical axis direction, an opening for connection to the lens flange 4 and the rear case 7. The front case 1 has side surfaces with substantially rectangular cross sections in a direction perpendicular to the optical axis to cover the optical axis. The front case 1 is connected to the lens flange 4 and the rear case 7 with the connection screws 82a to 82d to define a space for accommodating the lens barrel 2, the substrate 5, and other components. As shown in FIG. 1, the opening at the front in the optical axis direction in the front case 1 receives a lens 21 held in the lens barrel 2.

### Rear Case 7

As described above, the rear case 7 is connected to the lens flange 4 and the front case 1 with the connection screws 82a to 82d to define the space for accommodating the lens barrel 2, the substrate 5, and other components. The rear case 7 has flat surfaces including a surface substantially perpendicular to the optical axis.

### Lens Barrel 2

The lens barrel 2 is a cylinder elongated along the optical axis. The lens barrel 2 holds one or more optical members including the lens 21. The optical members held in the lens barrel 2 include, for example, a lens, a spacer, aperture blades, and an optical filter, in addition to the lens 21. The lenses including the lens 21 are formed from a transparent material, such as glass or plastic, to transmit light from the front to the rear in the optical axis direction while refracting the light. The spacer is an annular plate with an appropriate thickness in the optical axis direction. The spacer adjusts the positions of the lenses in the optical axis direction. The spacer has an opening in the middle including the optical axis. The aperture blades determine the outermost position of passing light. The optical filter prevents or blocks passage of light with a predetermined wavelength. The optical filter may include, for example, an infrared cut-off filter that prevents infrared rays from passing. The types and number of optical members used can be changed as appropriate.

The rear of the lens barrel 2 in the optical axis direction is cylindrical and received in a circular opening in the lens flange 4. The lens barrel 2 has an opening at the rear in the optical axis direction. Light from the front in the optical axis direction is transmitted through the optical members contained in the lens barrel 2, such as the lens 21, and travels through the opening to be incident on the image sensor 51 for exposure.

### Waterproof Seal 3

The waterproof seal 3 is annular, and is formed from an elastic material, such as rubber. The waterproof seal 3 is placed between the lens barrel 2 and the lens flange 4 to connect the lens barrel 2 and the lens flange 4 with no gap between them. The waterproof seal 3 is shaped in conformance with a contact area between the lens barrel 2 and the lens flange 4. In the present embodiment, the waterproof seal 3 is annular.

### Lens Flange 4

The lens flange 4 is located rearward from the lens barrel 2 in the optical axis direction. The lens flange 4 is a rectangular plate fitted with the lens barrel 2. The lens flange 4 has an opening. The opening in the lens flange 4 receives the rear cylindrical part of the lens barrel 2 in the optical axis direction. The lens flange 4 and the received lens barrel 2 are fitted together by thread engagement. The fitting between the lens barrel 2 and the lens flange 4 is not limited to thread engagement, but may be thread fitting such as cam engagement or other diameter fitting. The lens barrel 2 and the lens flange 4 may be screwed together to reduce or eliminate the use of an adhesive.

The lens flange 4 has through-holes at the four corners for receiving the connection screws 82a to 82d. During assembly, the connection screws 82a to 82d are placed through the through-holes to connect the lens flange 4 with the front case 1 and the rear case 7.

The rear surface of the lens flange 4 in the optical axis direction receives the substrate 5 connected with the connection screws 81a and 81b. The connection of the substrate 5 to the lens flange 4 during the assembly will be described later.

### Substrate 5

The substrate 5 is a rigid substrate on which electronic components including the image sensor 51 are mounted. Electrical signals generated in response to the image sensor 51 receiving light undergo predetermined electric or signal processing performed by the electronic components on the substrate 5. The processed signals are then output to a device external to the imaging device as image data.

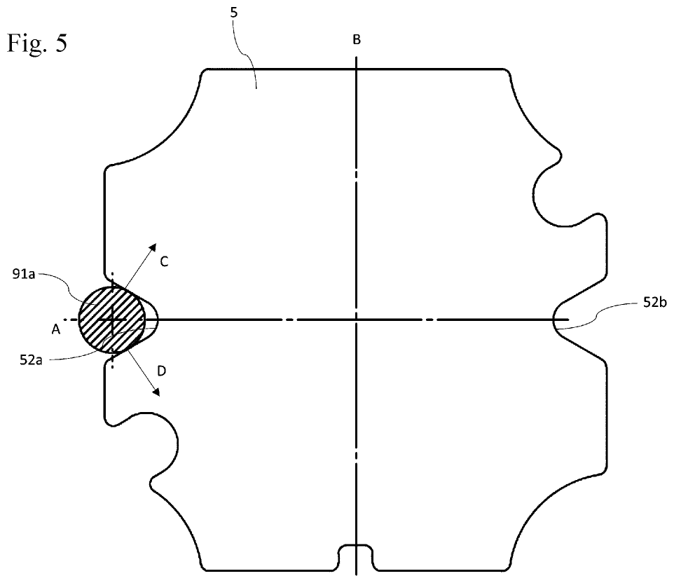

FIG. 5 is an enlarged front view of the substrate 5 according to the present embodiment. As shown in FIGS. 3 to 5, the substrate 5 has a first V-shaped portion 52a and a second V-shaped portion 52b that are aligned with a straight line A, among the straight lines A and B orthogonal to each other to have the optical axis at their intersection and also orthogonal to each side of the rectangular substrate 5 on a plane perpendicular to the optical axis. The first V-shaped portion 52a and the second V-shaped portion 52b are cutouts extending from the outer edges of the substrate 5 toward the optical axis. Each of the V-shaped portions 52a and 52b is defined by two straight lines. The two straight lines are connected at a rounded curve. One straight line defining the first V-shaped portion 52a and one straight line defining the second V-shaped portion 52b are parallel to each other. The other straight line defining the first V-shaped portion 52a and the other straight line defining the second V-shaped portion 52b are parallel to each other. The two straight lines defining the first V-shaped portion 52a are symmetrical about the straight line A, whereas the two straight lines defining the second V-shaped portion 52b are symmetrical about the straight line A. On the substrate 5, the straight lines defining the first V-shaped portion 52a and the second V-shaped portion 52b form an internal angle of about 30 degrees with the straight line A. Thus, the two straight lines defining each of the first V-shaped portion 52a and the second V-shaped portion 52b have an internal angle of about 60 degrees.

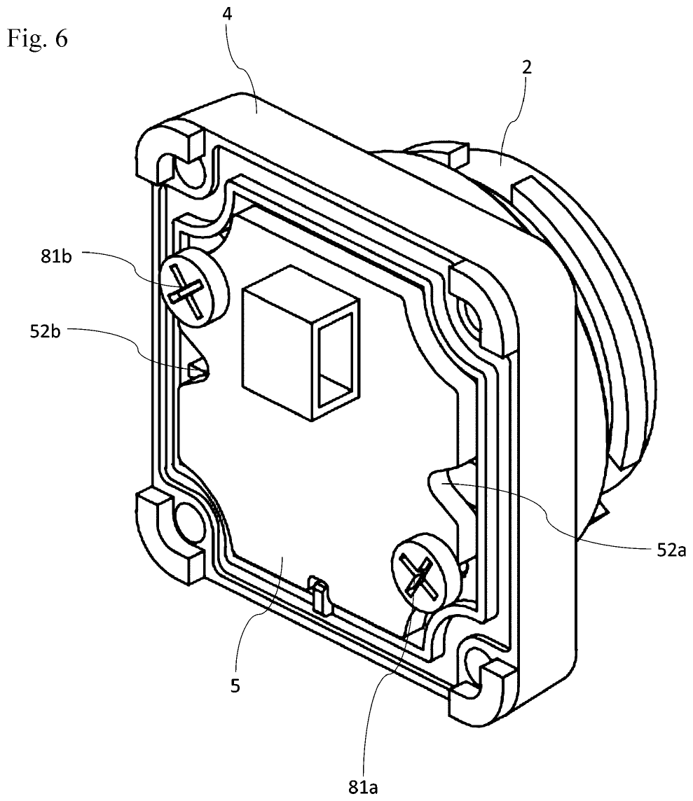

FIG. 6 is a rear view of the imaging device according to the present embodiment showing the lens barrel 2, the waterproof seal 3, the lens flange 4, and the substrate 5 connected together. As shown in FIG. 6, the substrate 5 is connected to the lens flange 4 with the connection screws 81a and 81b placed through cutouts located opposite to each other with respect to the optical axis.

The image sensor 51 is a photoelectric converter that converts incident light to electrical signals. The image sensor 51 is, for example, a complementary metal-oxide-semiconductor (CMOS) sensor or a charge-coupled device (CCD), but is not limited to such devices. The imaging device may include an imaging unit having the imaging function other than the image sensor 51. The image sensor may be referred to as an imaging unit.

Although the imaging device according to the present embodiment includes the single substrate 5 for mounting the image sensor 51 and other electronic components, the imaging device may include multiple substrates. In this case, one substrate is used for mounting an image sensor, and another substrate is used for mounting the electronic components other than the image sensor. The first V-shaped portion and the second V-shaped portion in the substrate 5 according to the present embodiment are primarily used to position and secure the image sensor 51. Thus, the first V-shaped portion and the second V-shaped portion are formed only in the substrate for mounting the image sensor. The other substrates may have no such portions.

### Waterproof Seal 6

Similarly to the waterproof seal 3, the waterproof seal 6 is formed from an elastic material, such as rubber. The waterproof seal 6 is placed between the lens flange 4 and the rear case 7 to connect the lens flange 4 and the rear case 7 with no gap between them. The waterproof seal 6 is shaped in conformance with the connection surface between the lens flange 4 and the rear case 7. The waterproof seal 6 in the present embodiment is rectangular and has cutouts in the corners.

Positioning with Respect to Optical Axis

Positioning with respect to the optical axis in the imaging device according to the present embodiment will now be described. As comparative examples of the present embodiment, substrates used have cutouts shaped differently from the cutouts in the structure according to the present embodiment.

In the structures according to both the present embodiment and the comparative examples, a jig 9 is used to position the image sensor 51 with respect to the optical axis when the substrate 5 (54 or 56) is connected to the lens flange 4 connected to the lens barrel 2 with the connection screws 81a and 81b. In assembling the imaging device, the waterproof seal 3 and the lens barrel 2 are first connected to the lens flange 4. The lens barrel 2 is secured to the lens flange 4 by thread engagement.

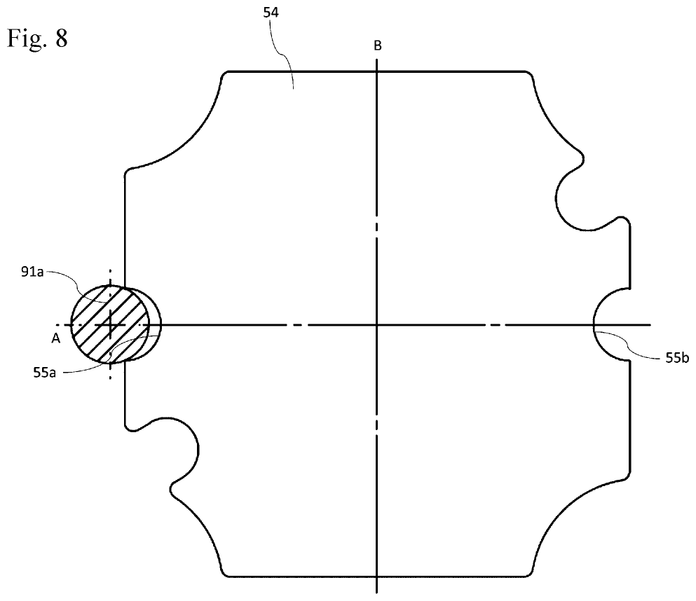

FIG. 8 is a diagram of a substrate 54 included in an imaging device according to a first comparative example. As shown in FIG. 8, the substrate 54 has cutouts 55a and 55b that are aligned with the straight line A as in the present embodiment. However, the cutouts 55a and 55b are not V-shaped, but are arc-shaped and have a smaller diameter than a protrusion 91a on the jig 9. When the substrate 54 having the cutouts 55a and 55b with such a shape is to be positioned, the jig 9 comes in contact with the edges of the cutouts 55a and 55b. The jig 9 can thus easily slip off the substrate 54 during securing of the substrate 54 to the lens flange 4 with connection screws. The substrate 54 may not be easily in position.

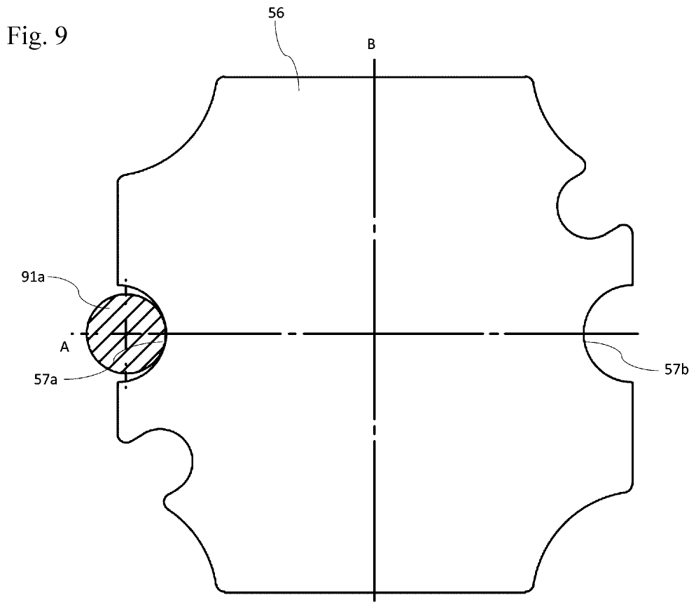

FIG. 9 is a diagram of a substrate 56 included in an imaging device according to a second comparative example. As shown in FIG. 9, the substrate 56 has cutouts 57a and 57b aligned with the straight line A as in the present embodiment. However, the cutouts 57a and 57b are not V-shaped, but are arc-shaped and have a larger diameter than the protrusion 91a on the jig 9. When the substrate 56 having the cutouts 57a and 57b with such a shape is to be positioned, the jig 9 comes in contact with inner portions of the arcs defining the cutouts 57a and 57b. The jig 9 can thus come in contact with the substrate 56 at a different position during securing of the substrate 56 to the lens flange 4 with connection screws. The substrate 56 may not easily be in position.

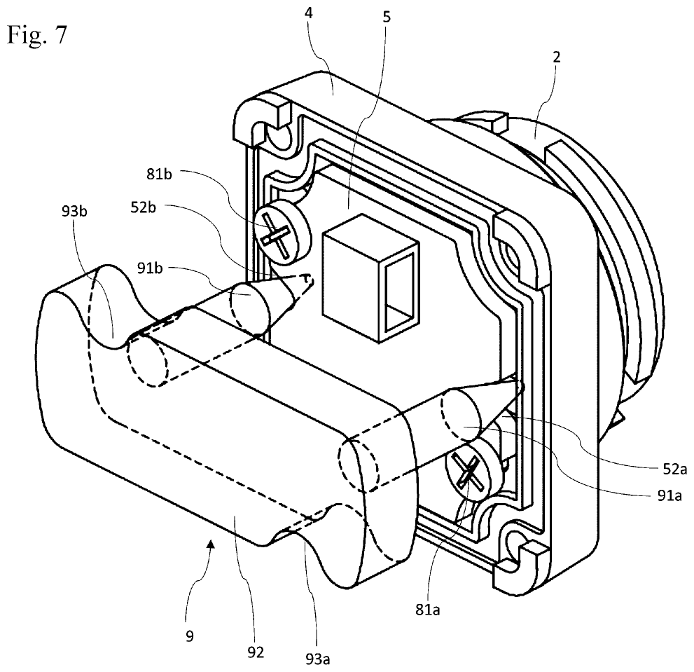

In the imaging device according to the present embodiment, the substrate 5 is positioned in the manner described below. FIG. 7 is a diagram describing positioning of the substrate 5 with respect to the lens flange 4 using the jig 9. To position the substrate 5 with respect to the lens flange 4, the substrate 5 is temporarily secured to the lens flange 4 with the connection screws 81a and 81b to avoid slipping off. The position of the substrate 5 is then adjusted using the jig 9. The jig 9 includes a body 92 and cylindrical protrusions 91a and 91b protruding from the body 92. The protrusions 91a and 91b have conical tips to be placed in the first V-shaped portion 52a and the second V-shaped portion 52b. The protrusions 91a and 91b are spaced from each other at a slightly smaller interval than the interval between the first V-shaped portion 52a and the second V-shaped portion 52b. The protrusions 91a and 91b are parallel to the optical axis. The conical tips of the protrusions 91a and 91b are thus each in contact with the two straight lines defining the first V-shaped portion 52a or the second V-shaped portion 52b. As the jig 9 is pressed frontward, the substrate 5 is pressed frontward.

In the state shown in FIG. 7, the jig 9 is moved to move the substrate 5. This changes the position of the image sensor 51. After the substrate 5 is positioned using the jig 9 with the image sensor 51 at an intended position with respect to the optical axis, the connection screws 81a and 81b are rotated with a tool, such as a screwdriver, placed through cutouts 93a and 93b in the body 92 of the jig 9 to secure the substrate 5 to the lens flange 4. When the connection screw 81a or 81b is rotated, the outer periphery of the protrusion 91a remains in point contact with one of the two straight lines defining the first V-shaped portion 52a as in FIG. 5 without misalignment. This structure reduces the possibility of misalignment or rotation of the substrate 5 that may occur when the connection screw 81a or 81b is rotated. Additionally, the force applied to the substrate 5 from the protrusions 91a and 91b on the jig 9 through the first V-shaped portion 52a and second V-shaped portion 52b can be distributed appropriately. The substrate 5 and the image sensor 51 can thus be positioned precisely.

In the imaging device according to the above embodiment, the substrate 5 has the first V-shaped portion 52a and the second V-shaped portion 52b. The substrate 5 is positioned with the jig applied to the straight lines of the first V-shaped portion 52a and the second V-shaped portion 52b. The substrate 5 can thus be positioned precisely without increasing the number of components. The image sensor 51 is thus positioned precisely with respect to the optical axis.

The first V-shaped portion 52a and the second V-shaped portion 52b may be located to appropriately transmit the force applied to the substrate 5 through the two straight lines defining each of the first V-shaped portion 52a and the second V-shaped portion 52b in any direction on the plane perpendicular to the optical axis. In some embodiments, the first V-shaped portion 52a and the second V-shaped portion 52b are not located on the facing sides of the substrate 5. For example, the first V-shaped portion 52a and the second V-shaped portion 52b may be located on adjacent sides of the substantially rectangular substrate 5.

More specifically, the intersection between the extensions of the two straight lines defining the first V-shaped portion 52a (a point on the straight line A in FIG. 5) and the intersection between the extensions of the two straight lines defining the second V-shaped portion 52b (a point on the straight line A in FIG. 5) may be symmetrical about a straight line perpendicular to the optical axis (the straight line B in FIG. 5). In this case, the straight line corresponding to the straight line B extends in any direction perpendicular to the optical axis. For example, in FIG. 5, the straight line B may extend diagonally. In this case, the first V-shaped portion and the second V-shaped portion are located on adjacent sides of the rectangle forming the substrate 5.

The substrate 5 may be polygonal or circular, rather than rectangular (or substantially rectangular).

In some embodiments, the first V-shaped portion 52a does not have a straight line parallel to a straight line of the second V-shaped portion 52b. However, when one straight line defining the first V-shaped portion 52a is parallel to one straight line defining the second V-shaped portion 52b and the other straight line defining the first V-shaped portion 52a is parallel to the other straight line defining the second V-shaped portion 52b, the force can be applied from the jig 9 to the substrate 5 in a balanced and intended manner.

In some embodiments, the first V-shaped portion 52a and the second V-shaped portion 52b are not aligned with the straight line A. To allow stable and precise positioning using the jig 9, the first and second V-shaped portions 52a and 52b may be located in opposite directions (at facing positions) with respect to the optical axis.

The imaging device according to the present embodiment includes the lens flange 4, and easily retains the substrate 5 in position with respect to the optical axis.

In the imaging device according to the present embodiment, the two straight lines defining each of the first V-shaped portion 52a and the second V-shaped portion 52b are symmetrical about the straight line A perpendicular to the optical axis. In other words, the two straight lines defining each of the first V-shaped portion 52a and the second V-shaped portion 52b are symmetrical about the straight line extending between the intersection of the straight lines defining the first V-shaped portion 52a and the intersection of the straight lines defining the second V-shaped portion 52b (more specifically, about the straight line A). Thus, the substrate 5 can be positioned with the jig 9 under a force from the jig 9 applied uniformly across the substrate 5. This easily allows more precise positioning of the substrate 5 with respect to the optical axis.

In the imaging device according to the present embodiment, the first V-shaped portion 52a and the second V-shaped portion 52b are cutouts each extending inward from the edges of the substrate 5. Thus, the substrate can be shaped relatively easily than a substrate with through-holes used as the first V-shaped portion 52a and the second V-shaped portion 52b formed inward from the edges of the substrate 5.

However, the first V-shaped portion 52a and the second V-shaped portion 52b may be through-holes located inward from the edges of the substrate 5, rather than the cutouts as in the present embodiment. In this case, the through-holes as the first V-shaped portion 52a and the second V-shaped portion 52b each have two straight lines as in the present embodiment.

In the imaging device according to the present embodiment, the substrate 5 is secured to the lens flange 4 with the connection screws 81a and 81b. Thus, the substrate 5 connected to the lens flange 4 can be disconnected from the lens flange 4. The imaging device with this structure is repairable, and also allows precise positioning of the substrate 5 with respect to the optical axis. The first V-shaped portion 52a and the second V-shaped portion 52b reduce the possibility of misalignment that may occur when the connection screws 81a and 81b are rotated to secure the substrate 5 to the lens flange 4.

In the imaging device according to the present embodiment, the two straight lines defining each of the first V-shaped portion 52a and the second V-shaped portion 52b form an internal angle of about 60 degrees. The first and second V-shaped portions 52a and 52b defined by appropriately angled straight lines easily allow more precise positioning of the substrate 5 with respect to the optical axis.

The internal angle between the straight lines defining the first V-shaped portion 52a or the second V-shaped portion 52b is not limited to about 60 degrees, and may be set as appropriate. The internal angle between the straight lines defining the first V-shaped portion 52a or the second V-shaped portion 52b may be in a range of about 60 to 90 degrees for stable positioning of the substrate 5 and for space availability on the substrate 5. The internal angle is not limited to the angle range specified above.

### 2. Supplemental Examples

The embodiment of the present invention has been described specifically. The embodiment described above is a mere example. The scope of the present invention is not limited to the embodiment, but is construed broadly within the scope understandable by those skilled in the art.

Although the imaging device in the above embodiment includes the single substrate 5 on which the image sensor 51 is mounted, the imaging device may include multiple substrates. In this case, one substrate is used for mounting an image sensor, and one or more other substrate are used for mounting electronic components.

The front case 1 and the rear case 7 are not limited to the structures described in the embodiment. For example, the front case 1 may include a plate member with a flat surface substantially perpendicular to the optical axis. The rear case 7 may include a plate member with a flat surface substantially perpendicular to the optical axis and side surfaces protruding frontward in the optical axis direction from the outer peripheries of the plate member. More specifically, the front case 1 and the rear case 7 may have any shapes that define a housing (case) when connected together. Also, the lens flange 4 may be placed inside the front case 1 and the rear case 7, rather than between the front case 1 and the rear case 7.

### INDUSTRIAL APPLICABILITY

The imaging device according to at least one embodiment of the present invention may be suitably used as an in-vehicle imaging device that involves particularly precise adjustment of the optical axis.

1. An imaging device, comprising:
a substrate on which an image sensor is mounted;
a lens barrel holding a lens; and
a case covering the substrate and the lens barrel,
wherein the substrate has a first V-shaped portion and a second V-shaped portion,
the first V-shaped portion includes a first straight line and a second straight line each extending straight on a plane perpendicular to an optical axis,
the second V-shaped portion includes a third straight line and a fourth straight line each extending straight on the plane perpendicular to the optical axis, and
the first straight line and the second straight line have an intersection located symmetrically to an intersection between the third straight line and the fourth straight line about a straight line perpendicular to the optical axis.

2. The imaging device, wherein
the substrate is substantially rectangular, and
the substrate has a first side having the first V-shaped portion and a second side having the second V-shaped portion, and the second side is opposite to the first side.

3. The imaging device according to claim 1, wherein
the first straight line is parallel to the third straight line, and the second straight line is parallel to the fourth straight line.

4. The imaging device according to claim 1, further comprising:
a lens flange holding the lens barrel and connected to the case,
wherein the substrate is secured to the lens flange.

5. The imaging device according to claim 1, wherein
the first straight line and the second straight line are symmetrical about the straight line perpendicular to the optical axis, and
the third straight line and the fourth straight line are symmetrical about the straight line perpendicular to the optical axis.

6. The imaging device according to claim 1, wherein
the first V-shaped portion and the second V-shaped portion are cutouts each extending inward from edges of the substrate.

7. The imaging device according to claim 1, wherein
the substrate is secured in position with a screw.

8. The imaging device according to claims 1, wherein
the first straight line forms an internal angle of about 60 degrees with the second straight line, and
the third straight line forms an internal angle of about 60 degrees with the fourth straight line.
